(19) United States
(12) Patent Application Publication
(10) Pub. No.: US 2024/0430520 A1
(43) Pub. Date: Dec. 26, 2024

(54) METHOD AND APPARATUS FOR ANALYZING CONTENT VIEWERS

(71) Applicant: XINAPSE CO., LTD., Seoul (KR)

(72) Inventors: Jin Beom KANG, Seoul (KR); Jae Seung ROH, Seoul (KR)

(73) Assignee: XINAPSE CO., LTD., Seoul (KR)

(21) Appl. No.: 18/427,111

(22) Filed: Jan. 30, 2024

(30) Foreign Application Priority Data
Jun. 20, 2023 (KR) 10-2023-0078839

(51) Int. Cl. H04N 21/442; G02B 27/00; G06Q 30/0272; G06V 40/16

(52) U.S. Cl. CPC H04N 21/44218; G02B 27/0093; G06Q 30/0272; G06V 40/178

(57) ABSTRACT

Provided is a method and apparatus for analyzing a viewer of content. A method includes collecting an image through a camera provided adjacent to an object of interest, detecting a face of a person from the image, analyzing the detected face of the person, determining, based on the analyzing, whether the detected person gazes at the object of interest, and generating object-of-interest viewing data associated with a person identified as being gazing at the object of interest.

### CROSS-REFERENCE TO RELATED APPLICATION

This application is based on and claims priority under 35 U.S.C. § 119 to Korean Patent Application No. 10-2023-0078839, filed on Jun. 20, 2023, in the Korean Intellectual Property Office, the disclosure of which is incorporated by reference herein in its entirety.

### BACKGROUND

### 1. Field

The present disclosure relates to a method and apparatus for analyzing a viewer of content.

### 2. Description of the Related Art

For a long time, devices that provide various pieces of content like outdoor advertisements and job postings have been installed in public places where citizens move freely, such as subways, bus stops, intersections, etc.

For content creators, especially, companies such as advertising companies, it may be important to use data such as the number of clicks, the number of visitors, the number of viewers, etc., to create marketing strategies.

In this respect, for content exposed in public places, such as outdoor advertisements and job postings, it is difficult to collect data about viewers, making it difficult to measure effects generated by the content.

The above-described background technology corresponds to technical information which has been possessed by the present inventor to contrive the present disclosure or which has been acquired in a process of contriving the present disclosure, and may not be necessarily regarded as well-known technology which had been known to the public prior to the filing of an application for the present disclosure.

### SUMMARY

The present disclosure provides a method and apparatus for analyzing a viewer of content. Problems that the present disclosure aims to solve are not limited to the problems mentioned above, and other problems and advantages of the present disclosure not mentioned may be understood from the following description and may be understood more clearly by embodiments of the present disclosure. In addition, it will be appreciated that the problems and advantages to be solved by the present disclosure may be realized by means and combinations thereof indicated in the claims.

Additional aspects will be set forth in part in the description which follows and, in part, will be apparent from the description, or may be learned by practice of the presented embodiments of the disclosure.

A first aspect of the present disclosure provides a method including collecting an image through a camera provided adjacent to an object of interest, detecting a face of a person from the image, analyzing the detected face of the person, determining, based on the analyzing, whether the detected person gazes at the object of interest, and generating object-of-interest viewing data associated with a person identified as being gazing at the object of interest.

A second aspect of the present disclosure an apparatus including a memory in which at least one program is stored and a processor configured to operate by executing the at least one program, in which the processor is further configured to collect an image through a camera provided adjacent to an object of interest, detect a face of a person from the image, analyze the detected face of the person, determine, based on the analyzing, whether the detected person gazes at the object of interest, and generate object-of-interest viewing data associated with a person identified as being gazing at the object of interest.

A third aspect of the present disclosure provides a computer-readable recording medium having recorded thereon a program for executing the method according to the first aspect on a computer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a system including a content providing device and a control server according to an embodiment.

FIG. 2 is a diagram schematically showing a content providing device according to an embodiment.

FIG. 3 is a diagram schematically showing a bounding box according to an embodiment of the present disclosure.

FIG. 4 is a diagram schematically showing key points according to an embodiment of the present disclosure.

FIG. 5 is a flowchart for explaining a process of updating object-of-interest viewing data according to an embodiment of the present disclosure.

FIG. 6 is a diagram schematically showing a statistical interface according to an embodiment of the present disclosure.

FIG. 7 is a flowchart of a method for analyzing a viewer of content according to an embodiment of the present disclosure.

FIG. 8 is a block diagram of an apparatus for analyzing a viewer of content according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Advantages and features of the present disclosure, and a method of achieving them will be apparent with reference to the embodiments described in detail in conjunction with the drawings. However, the present disclosure is not limited to the embodiments presented below, but may be implemented in various different forms, and should be understood to include all transformations, equivalents, and substitutes included in the spirit and technical scope of the present disclosure. Embodiments presented below are provided to complete the disclosure of the present disclosure and perfectly inform those of ordinary skill in the art of the category of the present disclosure. In describing the present disclosure, if it is determined that a detailed description of related known technologies may obscure the gist of the present disclosure, the detailed description thereof will be omitted.

The term used herein is used to describe particular embodiments, and is not intended to limit the present disclosure. Singular forms may include plural forms unless apparently indicated otherwise contextually. Herein, it should be understood that the term “include”, “have”, or the like used herein is to indicate the presence of features, numbers, steps, operations, components, parts, or a combination thereof described in the specifications, and does not preclude the presence or addition of one or more other features, numbers, steps, operations, components, parts, or a combination thereof.

Some embodiments of the present disclosure may be indicated with functional block configurations and various processing operations. Some or all of the functional blocks may be implemented with various numbers of hardware and/or software configurations executing particular functions. For example, the functional blocks of the present disclosure may be implemented by one or more microprocessors or circuit configurations for certain functions. Additionally, for example, functional blocks of the present disclosure may be implemented in various programming or scripting languages. Functional blocks may be implemented as algorithms running on one or more processors. In addition, the present disclosure may employ the prior art for electronic environment setup, signal processing, and/or data processing, etc. Terms such as “mechanism,” “element,” “means,” “configuration”, etc., will be used broadly and are not limited to mechanical and physical configurations.

Additionally, connection lines or connection members between components shown in the drawings merely exemplify functional connections and/or physical or circuit connections. In an actual device, connections between components may be represented by various replaceable or additional functional connections, physical connections, or circuit connections.

Hereinafter, the present disclosure will be described in detail with reference to the attached drawings.

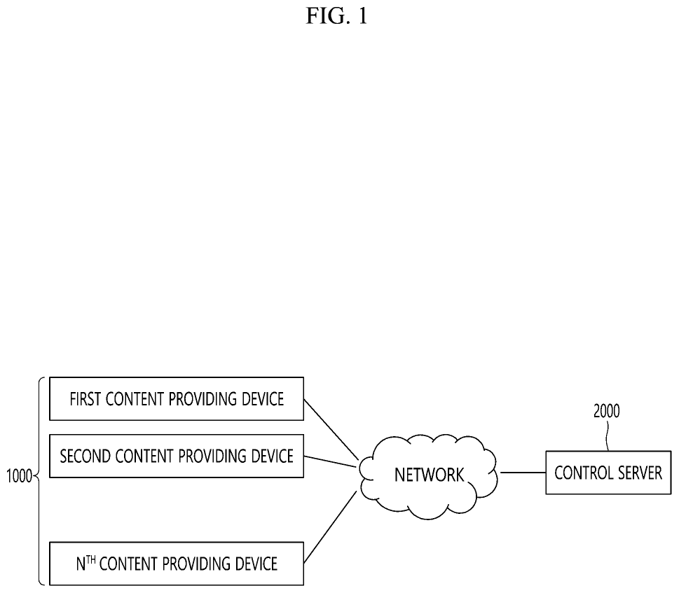

FIG. 1 is a diagram showing a system including a content providing device and a control server, according to an embodiment.

The system according to an embodiment may include one or more content providing devices 1000 and a control server 2000.

The content providing devices 1000 may communicate with one another or with other nodes through a network.

Each content providing device 1000 may also be understood as a specific device that forms a part of the content providing device 1000.

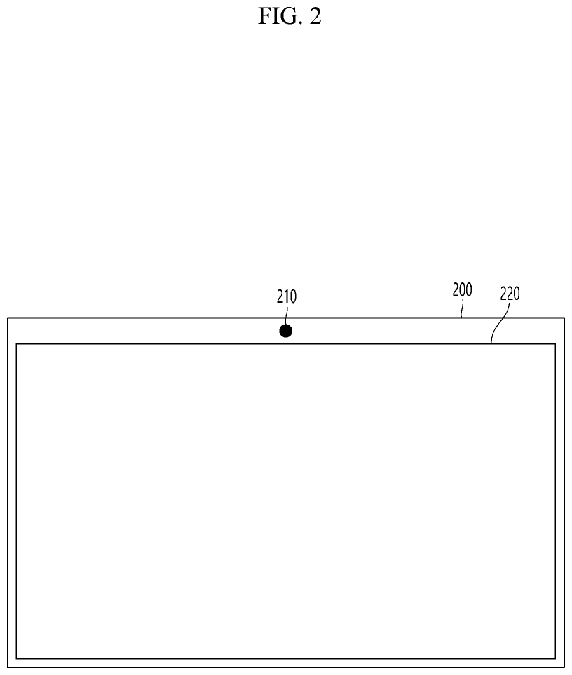

Each content providing device 1000 will be described in detail with reference to FIG. 2.

FIG. 2 is a diagram schematically showing a content providing device according to an embodiment.

A content providing device 200 may correspond to each content providing device 1000 of FIG. 1.

The content providing device 200 may include a camera 210. The camera 210 may be provided adjacent to a display 220, and the content providing device 200 may collect surrounding image data through the camera 210.

The content providing device 200 may include the display 220. The content providing device 200 may provide content by displaying it through the display 220. The content may include an image, for example, advertisements, promotional materials, job postings, notices, etc.

The display 220 may be any suitable display device for displaying content, such as a plasma display panel (PDP), a liquid crystal display (LCD), or a light emitting diode (LED), etc.

The content providing device 200 may further include various sensors for collecting surrounding context information. For example, the content providing device 200 may detect the movement of pedestrians through an image sensor and/or an event sensor mounted on a front surface thereof.

The content providing device 200 may further include a processor (not shown), a memory system (not shown), etc.

Data collected by sensors (including the camera 210) included in the content providing device 200 may be transmitted to the processor. The processor may process, in real time, the data collected by the sensors, and may store at least a part of the data collected by the sensors or the processed data in a memory system. The memory system may include two or more memory devices and a system controller for controlling the memory devices. Each of the memory devices may be provided as one semiconductor chip.

In addition to the system controller of the memory system, each of the memory devices included in the memory system may include a memory controller that may include an artificial intelligence (AI) operation circuit such as a neural network. The memory controller may generate operation data by applying a predetermined weight value to data received from the sensors or the processor, and store the operation data in a memory chip.

Referring back to FIG. 1, the content providing device 1000 may process data collected from the camera or the various sensors or transmit the data to the control server 2000.

The control server 2000 may be implemented as a computer device or a plurality of computer devices that communicate over the network to provide commands, codes, files, contents, services, etc.

The content providing device 1000 and the control server 2000 may communicate using the network. The control server 2000 may transmit content to be provided to the content providing device 1000 through the network or control the provision of the content by the content providing device 1000, based on the data received from the content providing device 1000.

Hereinbelow, operations performed by an apparatus for analyzing a viewer of content according to various embodiments of the present disclosure will be described. The apparatus for analyzing a viewer of content according to various embodiments may be the content providing device 1000 (or a part of the content providing device 1000) or the control server 2000 (or a part of the control server 2000).

The apparatus for analyzing a viewer of content according to the present disclosure may collect an image through a camera provided adjacent to an object of interest. The apparatus for analyzing a viewer of content according to the present disclosure may detect a face of a person from a collected image. The apparatus for analyzing a viewer of content according to the present disclosure may analyze the detected face of the person. The apparatus for analyzing a viewer of content according to the present disclosure may determine, based on the analysis, whether the detected person gazes at the object of interest. The apparatus for analyzing a viewer of content according to the present disclosure may generate object-of-interest viewing data associated with a person identified as being gazing at the object of interest. Hereinbelow, each operation of a method by which the apparatus for analyzing a viewer of content analyzes the viewers of the content will be described in detail.

As described above, the apparatus for analyzing the viewers of content according to the present disclosure may collect an image through the camera provided adjacent to the object of interest.

In the present disclosure, the term “object of interest” may be used to refer to an object to be analyzed in relation to the viewers, as an object of viewing. That is, the object of interest may be regarded as the above-described content providing device, and viewers watching content displayed on the content providing device will be analyzed. Meanwhile, the camera provided adjacent to the object of interest may correspond to the camera 210 included in the content providing device 200 described above. That is, the apparatus for analyzing a viewer of content according to the present disclosure may analyze an image collected through the camera to generate data regarding favorability of the object of interest, viewers interested in the object of interest, a time spent watching the object of interest, etc.

In the present disclosure, an image collected through the camera may include one or more frames, and the apparatus for analyzing a viewer of content may perform an operation of analyzing a viewer of content on a frame basis. Hereinbelow, a first frame may refer to a frame that is an object of current processing among the one or more frames constituting the image, and a second frame may refer to a frame that is an object of processing immediately before the first frame. That is, the second frame may be a frame preceding the first frame by one unit frame.

In an embodiment, the apparatus for analyzing a viewer of content may perform preprocessing on the collected image to make the collected image suitable for performing a subsequent operation. In an embodiment, preprocessing may be performed on the frame basis.

In an embodiment, the apparatus for analyzing a viewer of content may perform preprocessing to convert the size of the image on the frame basis.

In an embodiment, the apparatus for analyzing a viewer of content may perform preprocessing for normalizing pixel color (RGB) values of an image (pixel color values may be 0 to 255), on the frame basis. As a specific example, normalization may be performed by subtracting an average of 127.5 from a total pixel color value of one frame and dividing a subtraction result by a standard deviation of 128. Such normalization may be equally applied to both a learning procedure and an inference procedure of an AI inference model included in the apparatus for analyzing a viewer of content according to the present disclosure.

A detailed preprocessing process may differ depending on the performance of the apparatus based on the camera, the processor, etc.

As described above, the apparatus for analyzing a viewer of content according to the present disclosure may detect a face of a person from an image (including a preprocessed image).

The apparatus for analyzing a viewer of content according to the present disclosure may include an AI inference model for detecting a face of a person in which the AI inference model may be trained to detect a face of a person from input image data.

Meanwhile, faces of a plurality of persons may be detected from an image (or a frame), and although not separately described in the present disclosure, it would be easily understood by those of ordinary skill in the art that operations described below may be performed in parallel or in series with respect to each of the faces of the plurality of persons as many times as the number of faces of the persons.

In an embodiment, the apparatus for analyzing a viewer of content may generate a bounding box for the face of the person detected in the first frame.

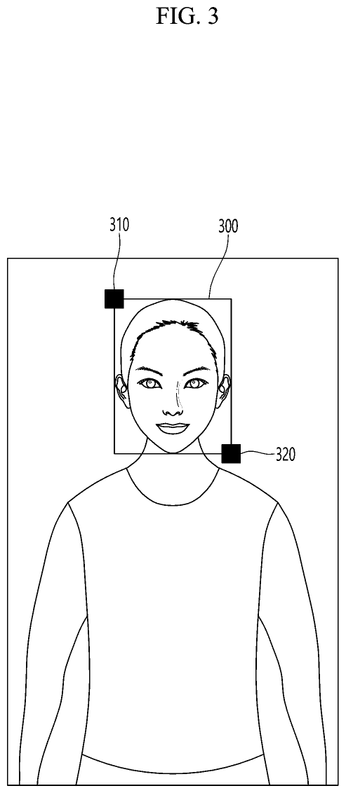

FIG. 3 is a diagram schematically showing a bounding box according to an embodiment of the present disclosure.

An image shown in FIG. 3 may correspond to the first frame among frames constituting the image collected through the camera.

In the present disclosure, the apparatus for analyzing a viewer of content may generate a bounding box 300 based on the detected face of the person.

In an embodiment, the bounding box 300 may include upper left coordinates 310 and lower right coordinates 320. That is, an apparatus for analyzing a viewer of content may create and identify the bounding box 300 within the first frame using the upper left coordinates 310 and the lower right coordinates 320. In the present disclosure, the coordinates may be expressed as an x coordinate value and a y coordinate value on the first frame, regarding the first frame as an x-y plane.

In an embodiment, the apparatus for analyzing a viewer of content may obtain a key point corresponding to the face of the person detected in the first frame.

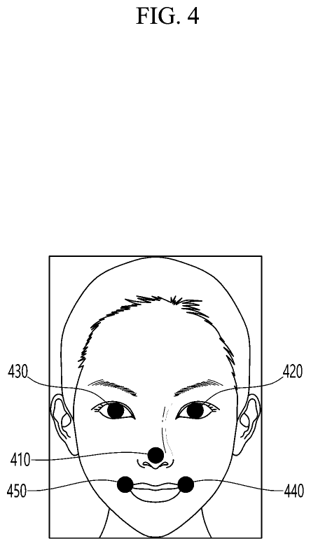

FIG. 4 is a diagram schematically showing key points according to an embodiment of the present disclosure.

In the present disclosure, the key point may refer to an element that may identify a person or determine a gaze among elements included in a face of the person. In an example shown in FIG. 4, the key point may be related to the nose, the left eye, the right eye, the left corner of the mouth, and the right corner of the mouth. That is, in an embodiment, the apparatus for analyzing a viewer of content may obtain a key point including coordinates of each of the nose, the left eye, the right eye, the left corner of the mouth, and the right corner of the mouth corresponding to the face of the person, detected in the first frame.

Referring to FIG. 4, coordinates 410 of the nose, coordinates 420 of the left eye, coordinates 430 of the right eye, coordinates 440 of the left corner of the mouth, and coordinates 450 of the right corner of the mouth, obtained by the apparatus for analyzing a viewer of content are shown.

In an embodiment, the apparatus for analyzing a viewer of content may estimate gender, age, etc., of a viewer of content based on the generated bounding box and the obtained key point, extract a facial feature of the viewer of the content, and determine whether the viewer of the content gazes at an object of interest.

As described above, the apparatus for analyzing a viewer of content according to the present disclosure may analyze the detected face of the person.

In an embodiment, analysis of the detected face of the person may include estimation of gender and age. That is, the apparatus for analyzing a viewer of content may determine the gender and age of the detected person. More specifically, the apparatus for analyzing a viewer of content may determine the gender and age based on a bounding box.

The apparatus for analyzing a viewer of content according to the present disclosure may include an AI inference model for determining gender and age in which the AI inference model may be trained to infer a gender and an age from input image data.

More specifically, by using an AI inference model that infers gender and age, a probability that a person in an input image is female, a probability that the person in the input image is male, and a value for the age of the person in the input image may be output in a range of 0 to 1, respectively. The gender may be determined corresponding to the greater value between the output probability of being female and the output probability of being male, and the age may be determined by multiplying the value for the age by 100 and rounding off below the decimal point.

In an embodiment, analysis of the detected face of the person may include extraction of a facial feature. In other words, the apparatus for analyzing a viewer of content may extract a facial feature of the detected person. More specifically, the apparatus for analyzing a viewer of content may extract a facial feature based on a key point.

The apparatus for analyzing a viewer of content according to the present disclosure may include an AI inference model to extract a facial feature, in which the AI inference model may be trained to extract a facial feature from input image data.

More specifically, by applying an affine transformation matrix using a key point, only data of a facial part corresponding to the key point may be extracted from an image, and data of the extracted facial part may be used as an input of the AI inference model for extracting a facial feature. By the AI inference model, a feature vector for the input extracted facial part may be output. The length of the feature vector may be, for example, 512.

By applying an affine transformation matrix using a key point based on the AI inference model for extracting a facial feature, the facial part corresponding to the key point may be extracted from the input image.

As described above, the apparatus for analyzing a viewer of content according to the present disclosure may determine whether the detected person gazes at an object of interest.

In an embodiment, the apparatus for analyzing a viewer of content according to the present disclosure may determine, based on a key point, whether the detected person gazes at the object of interest. More specifically, the apparatus for analyzing a viewer of content may determine, based on a correlation among the nose, the left eye, the right eye, the left corner of the mouth, and the right corner of the mouth, whether the detected person gazes at the object of interest.

In an embodiment, the apparatus for analyzing a viewer of content may determine that the detected person gazes at the object of interest when an x-coordinate value of the nose is greater than an x-coordinate value of the right eye and less than an x-coordinate value of the left eye (hereinafter, a first condition).

In an embodiment, the apparatus for analyzing a viewer of content may determine that the detected person gazes at the object of interest when a y-coordinate value of the nose is less than the less value between a y-coordinate value of the left corner of the mouth and a y-coordinate value of the right corner of the mouth and is greater than the greater value between a y-coordinate value of the left eye and a y-coordinate value of the right eye (hereinafter, a second condition).

In an embodiment, when both the first condition and the second condition are satisfied, it may be determined that the detected person gazes at the object of interest.

In addition to the first and second conditions described above, it may be determined that the detected person gazes at the object of interest, according to any suitable condition based on the obtained key point.

As described above, the apparatus for analyzing a viewer of content according to the present disclosure may generate object-of-interest viewing data associated with a person identified as being gazing at the object of interest.

In the present disclosure, the object-of-interest viewing data may refer to data related to the viewing of the object of interest, which is stored by being matched to information about the person of the detected face (including gender, age, facial feature, etc.), and may be a basis for calculating statistical data, such as a time for which a specific viewer or all viewers watch the object of interest, the gender distribution of the viewer of the object of interest, the age distribution of the viewer of the object of interest, etc.

In the present disclosure, the apparatus for analyzing a viewer of content according to the present disclosure may update the object-of-interest viewing data. Updating of the object-of-interest viewing data may be performed based on data collected, calculated, or generated by the apparatus for analyzing a viewer of content.

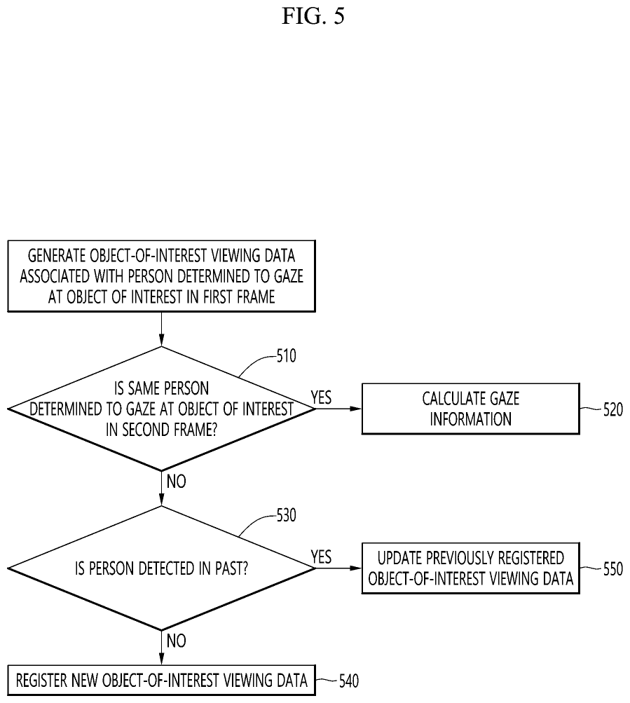

FIG. 5 is a flowchart for explaining a process of updating object-of-interest viewing data of interest according to an embodiment of the present disclosure.

In an embodiment, the apparatus for analyzing a viewer of content may update the object-of-interest viewing data based on a bounding box, a key point, and gaze information. The gaze information may refer to information related to the gazing behavior of a person identified as being gazing at the object of interest, and in an embodiment, the apparatus for analyzing a viewer of content may calculate the gaze information. For example, the gaze information may include a gaze time.

In an embodiment, the gaze time may be determined based on the number of frames, among a plurality of frames constituting an image, in which a person identified as being gazing at the object of interest maintains the gaze. That is, the gaze time may be calculated based on whether the person identified as being gazing at the object of interest in a first frame is identified as being gazing at the object of interest in a second frame preceding the first frame. In an embodiment, a total gaze time may be calculated by converting, into time, the number of frames between a frame where the gaze starts and a frame where the gaze ends. In another embodiment, the total gaze time may be calculated by dividing the total number of frames in which it is identified as being gazing at the object of interest by frames per second (fps).

Referring to FIG. 5, in an embodiment, the apparatus for analyzing a viewer of content may determine whether a person identified as being gazing at an object of interest in a first frame is identified as being gazing at the object of interest in a second frame, when object-of-interest viewing data related to the person identified as being gazing at the object of interest in the first frame is generated, in operation 510.

When a person identified as being gazing at the object of interest in a frame is not identified as being gazing at the object of interest in a previous frame, it may mean that the person is a newly appearing person without appearing (i.e., not detected) in the previous frame in an image collected by the camera or a person appearing in the previous frame, but not gazing at the object of interest.

In an embodiment, whether a person identified as being gazing at the object of interest in the first frame is identified as being gazing at the object of interest in the second frame may be determined by calculating an intersection over union (IoU) between a bounding box in the first frame and a bounding box in the second frame. The loU may mean dividing an area of an intersection between two regions by an area of a union between them.

In an embodiment, the apparatus for analyzing a viewer of content may determine that the person identified as being gazing at the object of interest in the first frame is identified as being gazing at the object of interest in the second frame, when the loU between the bounding box in the first frame and the bounding box in the second frame is greater than or equal to a threshold value. On the other hand, the apparatus for analyzing a viewer of content may determine that the person identified as being gazing at the object of interest in the first frame is not identified as being gazing at the object of interest in the second frame, when the loU between the bounding box in the first frame and the bounding box in the second frame is less than the threshold value. That is, the apparatus for analyzing a viewer of content may perform comparison between frames based on a similarity between regions of the bounding boxes.

In an embodiment, when the person identified as being gazing at the object of interest in the first frame is identified as being gazing at the object of interest in the second frame, the apparatus for analyzing a viewer of content may calculate gaze information in operation 520. That is, when a gaze state of a specific person continues, gaze information may be calculated while a gaze time being accumulatively updated.

In an embodiment, the calculated gaze information may be used to update object-of-interest viewing data associated with the person identified as being gazing at the object of interest.

In an embodiment, when the person identified as being gazing at the object of interest in the first frame is not identified as being gazing at the object of interest in the second frame, the apparatus for analyzing a viewer of content may determine whether the person identified as being gazing at the object of interest in the first frame is a person detected in the past, in operation 530.

In the present disclosure, the term “past” may mean “before a threshold time or more” by converting a unit frame into time. The threshold time may be, for example, 1 minute, 30 minutes, 1 hour, etc.

In an embodiment, the apparatus for analyzing a viewer of content may determine whether the person identified as being gazing at the object of interest in the first frame is a person detected in the past, based on whether data including a facial feature similar to a facial feature corresponding to the person identified as being gazing at the object of interest in the first frame (e.g., previously registered object-of-interest viewing data to be described later).

In an embodiment, a similarity between facial features may be calculated based on a distance between feature vectors for a facial part. More specifically, the similarity between the facial features may be calculated using a cosine similarity. When the cosine similarity is used, the less the distance between feature vectors, the greater the similarity may be.

In an embodiment, the apparatus for analyzing a viewer of content may compare a facial feature corresponding to the person identified as being gazing at the object of interest in the first frame with each of one or more facial features stored in the preserved data and calculate the greatest similarity. In an embodiment, in similarity calculation, for speed optimization thereof, a tree-based similarity search algorithm may be used.

In an embodiment, the apparatus for analyzing a viewer of content may determine that the person identified as being gazing at the object of interest in the first frame is a person detected in the past, when the greatest similarity is greater than or equal to a threshold value as a result of the similarity calculation. In an embodiment, the apparatus for analyzing a viewer of content may determine that the person identified as being gazing at the object of interest in the first frame is not a person detected in the past, when the greatest similarity is less than or equal to the threshold value.

In an embodiment, when it is determined that the person identified as being gazing at the object of interest in the first frame is not the person detected in the past, the apparatus for analyzing the viewer of content may register the generated object-of-interest viewing data as new object-of-interest viewing data in operation 540. That is, the apparatus for analyzing a viewer of content may generate object-of-interest viewing data associated with the person identified as being gazing at the object of interest in the first frame. This is because there is no object-of-interest viewing data associated with the person identified as being gazing at the object of interest in the first frame.

In an embodiment, when it is determined that the person identified as being gazing at the object of interest in the first frame is the person detected in the past, the apparatus for analyzing a viewer of content may update previously registered object-of-interest viewing data based on the generated object-of-interest viewing data in operation 550. In other words, the apparatus for analyzing a viewer of content may update the previously stored object-of-interest viewing data without a need to newly register the generated object-of-interest viewing data because there is already object-of-interest viewing data associated with the person identified as being gazing at the object of interest in the first frame. In an embodiment, the previously registered object-of-interest viewing data may be object-of-interest viewing data corresponding to a facial feature having the greatest similarity to a facial feature corresponding to the person identified as being gazing at the object of interest in the first frame.

As can be easily inferred from the foregoing description, after one frame from when, i.e., immediately after new object-of-interest viewing data is generated because the person identified as being gazing at the object of interest in the first frame is not detected in the past, when it is determined that the same person gazes at the object of interest in the third frame to be processed, the gaze information may be calculated while the gaze time being accumulatively updated, and the object-of-interest viewing data may be updated based on the calculated gaze information. Herein, the third frame may be a frame following the first frame after one unit frame.

In an embodiment, the apparatus for analyzing a viewer of content may generate a statistical interface based on object-of-interest viewing data. A statistical interface may refer to an interface that allows users to identify information related to an object of interest, content, or a content provision device by displaying data collected, calculated, or generated by the apparatus for analyzing a viewer of content after going through a series of processing processes. Through the statistical interface, a content creator may analyze a viewer watching content to apply a result of the analysis to establishment of marketing strategies.

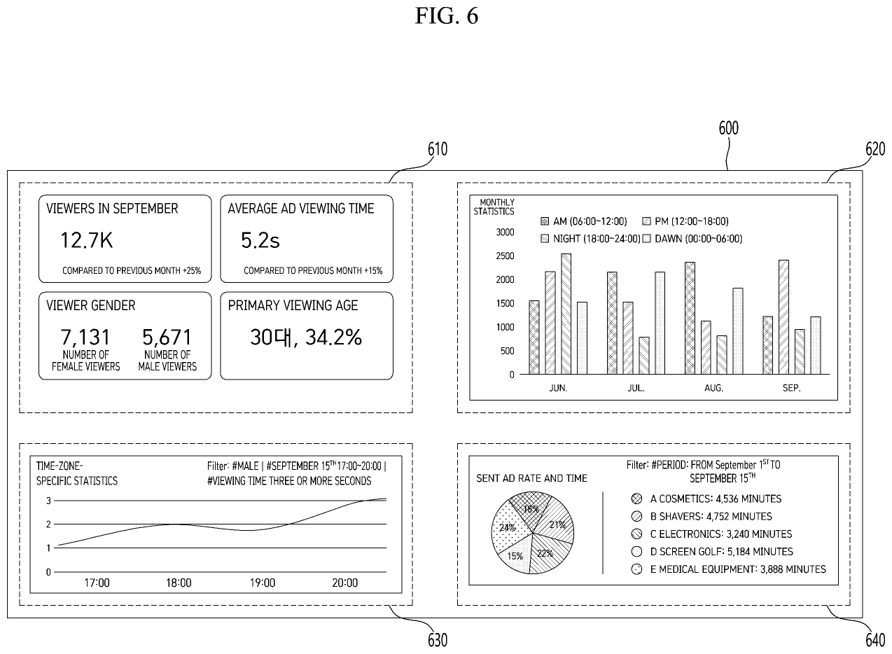

FIG. 6 is a diagram schematically showing a statistical interface according to an embodiment of the present disclosure.

In an embodiment, a statistical interface 600 may include a statistical summary interface 610. The statistical summary interface 610 may refer to an interface that allows a user to check, at a glance, summarized values related to viewing of the object of interest. For example, the statistical summary interface 610 may include statistical data regarding the number of viewers, an average viewing time, the number of viewers by gender, and a primary viewing age group, for the object of interest. In an embodiment, the statistical summary interface 610 may include additional statistics or exclude some statistical data as the user configures which statistics to display.

In an embodiment, the statistical interface 600 may include a period-specific statistical interface 620. The period-specific statistical interface 620 may refer to an interface that displays statistics on the number of viewers on a period basis. For example, the period-specific statistical interface 620 may include statistics on a monthly viewing time. In an embodiment, the period-specific statistical interface 620 may further include an interface that may filter data that is the target of statistics calculation.

In an embodiment, the statistical interface 600 may include a time-zone-specific statistical interface 630. The time-zone-specific statistical interface 630 may refer to an interface that displays statistics on the number of viewers on a time-zone basis. For example, the time-zone-specific statistical interface 630 may include statistics on a viewing time of the object of interest over time during the day. In an embodiment, the time-zone-specific statistical interface 630 may further include an interface that may filter data that is the target of statistics calculation. In an example shown in FIG. 6, only data corresponding to ‘male viewers’, ‘a specific time on a specific date’, and ‘a gaze time of three or more seconds’ may be filtered and calculated as statistics on the time-zone-specific statistical interface 630.

In an embodiment, the statistical interface 600 may include a content-specific statistical interface 640. The content-specific statistical interface 640 may refer to an interface that displays viewing statistics for each of one or more pieces of content included in the object of interest. In an embodiment, the object of interest may include one or more pieces of content. For example, the object of interest may include one or more advertising images that are periodically circulated. Viewers watching the object of interest may differ depending on the type of content, and accordingly, the content-specific statistical interface 640 may include viewing statistics calculated according to the content.

In addition, the statistical interface 600 may include any suitable statistics that may provide useful information to content creators by processing the object-of-interest viewing data.

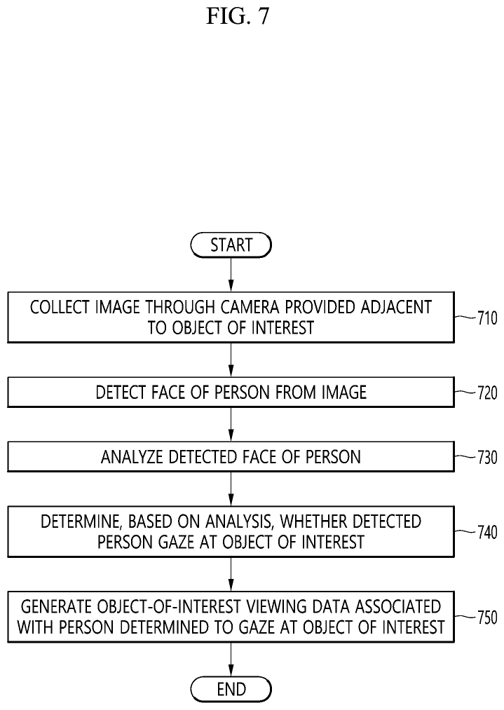

FIG. 7 is a flowchart of a method for analyzing a viewer of content according to an embodiment of the present disclosure.

Operations shown in FIG. 7 may be executed by the apparatus for analyzing a viewer of content described above. More specifically, the operations shown in FIG. 7 may be executed by a processor included in the apparatus for analyzing a viewer of content described above.

In operation 710, the processor may collect an image through a camera provided adjacent to an object of interest.

In operation 720, the processor may detect a face of a person from the image.

In an embodiment, operation 720 may include generating a bounding box for the detected face of the person in a first frame included in the image.

In an embodiment, operation 720 may include obtaining a key point including coordinates of each of the nose, the left eye, the right eye, the left corner of the mouth, and the right corner of the mouth corresponding to the face of the person, detected in the first frame.

In operation 730, the processor may analyze the detected face of the person.

In an embodiment, operation 730 may include determining a gender and an age of the detected person based on a bounding box.

In an embodiment, operation 730 may include extracting a facial feature of the detected person based on a key point.

In operation 740, the processor may determine whether the detected person gazes at the object of interest based on analysis.

In an embodiment, operation 740 may determine whether the person of the detected face gazes at the object of interest, based on a correlation among the coordinates of each of the nose, the left eye, the right eye, the left corner of the mouth, and the right corner of the mouth, included in the key point.

In operation 750, the processor may generate object-of-interest viewing data associated with the person identified as being gazing at the object of interest.

In an embodiment, operation 750 may include calculating gaze information for the person identified as being gazing at the object of interest.

In an embodiment, the gaze information may include a gaze time.

In an embodiment, the gaze time may be calculated based on whether the person identified as being gazing at the object of interest in a first frame is identified as being gazing at the object of interest in a second frame preceding the first frame.

In an embodiment, whether the person identified as being gazing at the object of interest in the first frame is identified as being gazing at the object of interest in the second frame may be determined by calculating an loU between a bounding box in the first frame and a bounding box in the second frame.

In an embodiment, after operation 750, the processor may update the object-of-interest viewing data based on the bounding box, the keypoint, and the gaze information.

In an embodiment, the operation of updating the object-of-interest viewing data may include determining whether the detected person is a person detected in the past, registering new object-of-interest viewing data as the object-of-interest viewing data in response to determining that the detected person is not the person detected in the past, and updating previously registered object-of-interest viewing data with the object-of-interest viewing data based on the generated object-of-interest viewing data, in response to determining that the detected person is the person detected in the past.

In an embodiment, after operation 750, the processor may generate a statistical interface based on the object-of-interest viewing data.

In an embodiment, the statistical interface may include a statistical summary interface that displays, for the object of interest, the number of viewers, an average viewing time, the number of viewers by gender, and a primary viewing age group, a period-specific statistical interface that displays statistics of the number of viewers on a period basis, a time-zone-specific statistical interface that displays statistics on the number of viewers on a time-zone basis, and a content-specific statistical interface that displays viewing statistics for each of one or more pieces of content included in the object of interest.

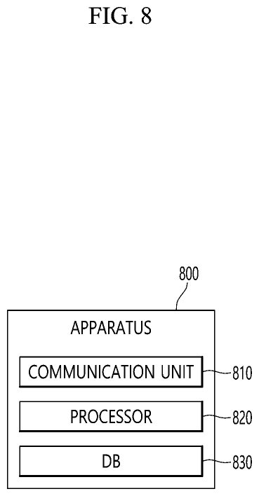

FIG. 8 is a block diagram of an apparatus for analyzing a viewer of content according to an embodiment of the present disclosure.

Referring to FIG. 8, an apparatus 800 for analyzing a viewer of content may include a communication unit 810, a processor 820, and a database (DB) 830. In the apparatus 800 for analyzing a viewer of content in FIG. 8, only components related to the embodiment are shown. Accordingly, those of ordinary skill in the art may understand that other general-purpose components may be included in addition to the components shown in FIG. 8.

The communication unit 810 may include one or more components that enable wired/wireless communication with an external server or external device. For example, the communication unit 810 may include at least one of a short-range communication unit (not shown), a mobile communication unit (not shown), and a broadcast receiver (not shown).

The DB 830 may be hardware that stores various data processed in the apparatus 800 for analyzing a viewer of content, and may store programs for processing and control of the processor 820. The DB 830 may store payment information, user information, etc.

The DB 830 may include random access memory (RAM) such as dynamic random access memory (DRAM), static random access memory (SRAM), etc., read-only memory (ROM), electrically erasable programmable read-only memory (EEPROM), compact disk (CD)-ROM, Blu-ray or other optical disk storages, hard disk drive (HDD), solid state drive (SSD), or flash memory.

The processor 820 may control the overall operation of the apparatus 800 for analyzing a viewer of content. For example, the processor 820 may generally control an input unit (not shown), a display (not shown), the communication unit 810, the DB 830, etc., by executing programs stored in the DB 830. The processor 820 may control an operation of the apparatus 800 for analyzing a viewer of content by executing the programs stored in the DB 830.

The processor 820 may control at least some of the operations of the apparatus 800 for analyzing a viewer of the content described above in FIGS. 1 to 7.

The processor 820 may be implemented using at least one of application specific integrated circuits (ASICs), digital signal processors (DSPs), digital signal processing devices (DSPDs), programmable logic devices (PLDs), field programmable gate arrays (FPGAs), controllers, microcontrollers, microprocessors, and other electrical units for performing functions.

An embodiment of the present disclosure may be implemented in the form of a computer program executable on a computer through various components, and the computer program may be recorded on a computer-readable medium. The medium may include a hardware device specially configured to store and execute a program instruction, like a magnetic medium such as a hard disk, a floppy disk, and a magnetic tape, an optical recording medium such as a CD-ROM and a DVD, a magneto-optical medium such as a floptical disk, ROM, RAM, flash memory, etc.

Meanwhile, the computer program may be a program command specially designed and configured for the disclosure or a program command known to be used by those of ordinary skill in the art of the computer software field. Examples of the computer program may include not only a machine language code created by a complier, but also a high-level language code executable by a computer using an interpreter.

According to an embodiment of the disclosure, a method according to various embodiments of the present disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices directly. In the case of online distribution, at least a part of a computer program product may be at least temporarily stored in a machine-readable storage medium such as a memory of a server of a manufacturer, a server of an application store, or a relay server, or may be generated temporarily.

When there is no apparent description of the order of operations constituting the method according to the embodiments or a contrary description thereof, the operations may be performed in an appropriate order. However, the present disclosure is not necessarily limited according to the describing order of the operations. The use of all examples or exemplary terms (for example, etc.) in the present disclosure are to simply describe the present disclosure in detail, and unless the range of the present disclosure is not limited by the examples or the exemplary terms unless limited by the claims. In addition, it may be understood by those of ordinary skill in the art that various modifications, combinations, and changes may be made according to design conditions and factors within the scope of the appended claims or equivalents thereof.

Thus, the spirit of the present disclosure should not be determined by being limited to the above-described embodiments, and not only the claims to be described later, but also any range equivalent to or equivalently changed from the claims falls within the scope of the spirit of the present disclosure.

According to various embodiments of the present disclosure, it is possible to collect data about viewers even in the case of content exposed in public places, thereby enabling content creators to analyze effects caused by the content.

In particular, by analyzing the viewers watching the content and generating data related to the viewers, it is possible to analyze the favorability of the content according to gender, age, etc., and the viewing status according to the time zone, thereby increasing the effectiveness of content provision.

In addition, when the apparatus for analyzing a viewer of content according to various embodiments of the present disclosure is implemented as a content providing device or as a part thereof, calculation on a server may be minimized, leading to a high speed and a superior scalability.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method comprising:
collecting an image through a camera provided adjacent to an object of interest;
detecting a face of a person from the image;
analyzing the detected face of the person;
determining, based on the analyzing, whether the detected person gazes at the object of interest; and
generating object-of-interest viewing data associated with a person identified as being gazing at the object of interest.

2. The method of claim 1, wherein the detecting of the face of the person comprises:
generating a bounding box for the face of the person detected in a first frame included in the image; and
obtaining a key point comprising coordinates of each of a nose, a left eye, a right eye, a left corner of a mouth, and a right corner of the mouth which correspond to the face of the person detected in the first frame.

3. The method of claim 2, wherein the analyzing of the detected face of the person comprises:
determining a gender and an age of the detected person based on the bounding box; and
extracting a facial feature of the detected person based on the key point.

4. The method of claim 2, wherein the determining of whether the person gazes at the object of interest comprises determining whether the person of the detected face gazes at the object of interest, based on a correlation among the coordinates of each of the nose, the left eye, the right eye, the left corner of the mouth, and the right corner of the mouth, included in the key point.

5. The method of claim 2, wherein the generating of the object-of-interest viewing data comprises calculating gaze information of the person identified as being gazing at the object of interest, and the method further comprises updating the object-of-interest viewing data based on the bounding box, the key point, and the gaze information.

6. The method of claim 5, wherein the gaze information comprises a gaze time, and the gaze time is calculated based on whether the person identified as being gazing at the object of interest in the first frame is identified as being gazing at the object of interest in a second frame preceding the first frame.

7. The method of claim 6, wherein whether the person identified as being gazing at the object of interest in the first frame is identified as being gazing at the object of interest in the second frame is determined by calculating an intersection over union (IoU) between a bounding box in the first frame and a bounding box in the second frame.

8. The method of claim 5, wherein the updating of the object-of-interest viewing data comprises:
determining whether the detected person is a person detected in the past; and
registering new object-of-interest viewing data as the object-of-interest viewing data in response to determining that the detected person is not the person detected in the past, and updating previously registered object-of-interest viewing data based on the object-of-interest viewing data, in response to determining that the detected person is the person detected in the past.

9. The method of claim 1, further comprising generating a statistical interface based on the object-of-interest viewing data,
wherein the statistical interface comprises:
a statistical summary interface that displays, for the object of interest, a number of viewers, an average viewing time, a number of viewers by gender, and a primary viewing age group;
a period-specific statistical interface that displays statistics of the number of viewers on a period basis;
a time-zone-specific statistical interface that displays statistics on the number of viewers on a time-zone basis; and
a content-specific statistical interface that displays viewing statistics for each of one or more pieces of content included in the object of interest.

10. An apparatus comprising:
a memory storing at least one program; and
a processor configured to operate by executing the at least one program,
wherein the processor is further configured to:
collect an image through a camera provided adjacent to an object of detect a face of a person from the image;
analyze the detected face of the person;
interest;
determine, based on the analyzing, whether the detected person gazes at the object of interest; and
generate object-of-interest viewing data associated with a person identified as being gazing at the object of interest.

11. A non-transitory computer-readable recording medium having recorded thereon a program for causing a computer to execute the method of claim 1.
